(19) United States
(12) Patent Application Publication
(10) Pub. No.: US 2013/0139198 A1
(43) Pub. Date: May 30, 2013

(54) DIGITAL TRANSPORT ADAPTER REGIONALIZATION

(71) Applicants: John I. Okimoto, San Diego, CA (US); Alexander Medvinsky, San Diego, CA (US); Xin Qiu, San Diego, CA (US)

(72) Inventors: John I. Okimoto, San Diego, CA (US); Alexander Medvinsky, San Diego, CA (US); Xin Qiu, San Diego, CA (US)

(73) Assignee: GENERAL INSTRUMENT CORPORATION, Horsham, PA (US)

(21) Appl. No.: 13/305,958

(22) Filed: Nov. 29, 2011

(51) Int. Cl. H04N 21/2347

(52) U.S. Cl. 725/31

(57) ABSTRACT

A method, a digital content consumption device, and a conditional access system are disclosed. A network interface may receive in a digital content consumption device a public key message that includes an encrypted key. A processor may decrypt the encrypted key using a secret key to produce the transmitted public key, identify a region descriptor in the public key message, and determine the secret key based on the region descriptor.

### FIELD OF THE INVENTION

The present invention relates to a method and system for regionalizing a digital content consumption device. The present invention further relates to using a secret key to decrypt a transmitted public key.

### INTRODUCTION

A standard set-top box allows a television to play digital television transmissions. A digital content consumption device may be used as an extremely low-end set top box that allows an analog or digital television to view a digital transmission. The television sets may use the digital content consumption devices to view transmissions that use a conditional access security system.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings in which:

FIG. 1 illustrates, in a block diagram, one embodiment of a digital media network.

FIG. 2 illustrates, in a block diagram, one embodiment of a computer device that may act as a conditional access system.

FIG. 3 illustrates, in a block diagram, one embodiment of a digital content consumption device.

FIG. 4 illustrates, in a block diagram, one embodiment of a public key update transmission.

FIG. 5 illustrates, in a flowchart, one embodiment of a method for updating a public key in a digital content consumption device.

FIG. 6 illustrates, in a flowchart, one embodiment of a method for forwarding a public key update transmission to a digital content consumption device.

FIG. 7 illustrates, in a flowchart, one embodiment of a method for receiving a public key update transmission in a digital content consumption device.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, a digital content consumption device, and a conditional access system, and other embodiments that relate to the basic concepts of the invention. The conditional access system or digital content consumption device may be any manner of computer, electronic device, or communication device.

A method, a digital content consumption device, and a conditional access system are disclosed. A network interface may receive in a digital content consumption device a public key message that includes an encrypted key. A processor may decrypt the encrypted key using a secret key to produce the transmitted public key.

A conditional access system may forward a public key message to a digital content consumption device to allow the digital content consumption device to validate or preferably decrypt control messages from the conditional access system or from the digital content server. A conditional access system may receive a public key message preformatted from an offline secure facility. An administrator from the offline secure facility may remove the public key message from a secure vault and transmit the public key message on a separate server, maintaining the offline nature of the secure facility. The conditional access system may forgo executing any processing on the public key message other than ensuring the public key message is inserted into transport streams appropriately for a digital content consumption device. Thus, the format of the public key message may be altered without otherwise affecting functionality in any part of the system aside from the final digital content consumption device destination. The public key message may be “regionalized” without impact to the content delivery system. The digital content consumption devices may have corresponding “regionalization” adjustments to align with a regionalized public key message.

Thus, the public key message may be customized for each region. The public key message may deliver a transmitted public key the digital content consumption device uses to authenticate all other control messages.

A 1024 bit Rivest, Shamir and Adleman (RSA) public key modulus may be encrypted by an ordinary 128 bit Advanced Encryption Standard cipher block chaining (AES-CBC) algorithm. The Advanced Encryption Standard key and initialization vector used for the encryption may become the “licensed” parameters that digital content consumption devices may possess along with knowledge of the encryption algorithm. The region key and initialization vector may be obfuscated in software or stored in a secure hardware location to provide additional support for region isolation.

A digital content consumption device may simply perform the decryption on the public key modulus on an ad hoc basis on the region number in the public key message, prior to processing the public key message. Each digital content consumption device may support one or more regions as deemed appropriate, by adding code to support the licensed key and initialization vector for each region. With a regionalized public key message, a digital content consumption device may use correct region information in order to proceed, while the full functionality of the public key message is still retained.

Additionally, the region may be segregated into a separate descriptor. The public key message may deliver the transmitted public key in an entirely different manner for each region. Since the conditional access system does not process the public key message, the format of the public key message may be changed completely, provided the digital content consumption device is implemented to support the change. The regionalization may be further tailored by altering the encryption of the public key modulus individually per region, for additional isolation.

A regionalized key and initialization vector parameters may be updated dynamically. A messaging mechanism may deliver a new regionalized key and initialization vector parameters to a digital content consumption device. Alternatively, an updated digital content consumption device code download may provide a new regionalized key and initialization vector parameters.

Additionally, the public key message may indicate to the digital content consumption device which regionalized key and initialization vector parameters are in current use for the given region. Alternatively, if the public key has been signed, the digital content consumption device may decrypt the public key message with all available key and initialization vector parameters for a given region and verify the signature.

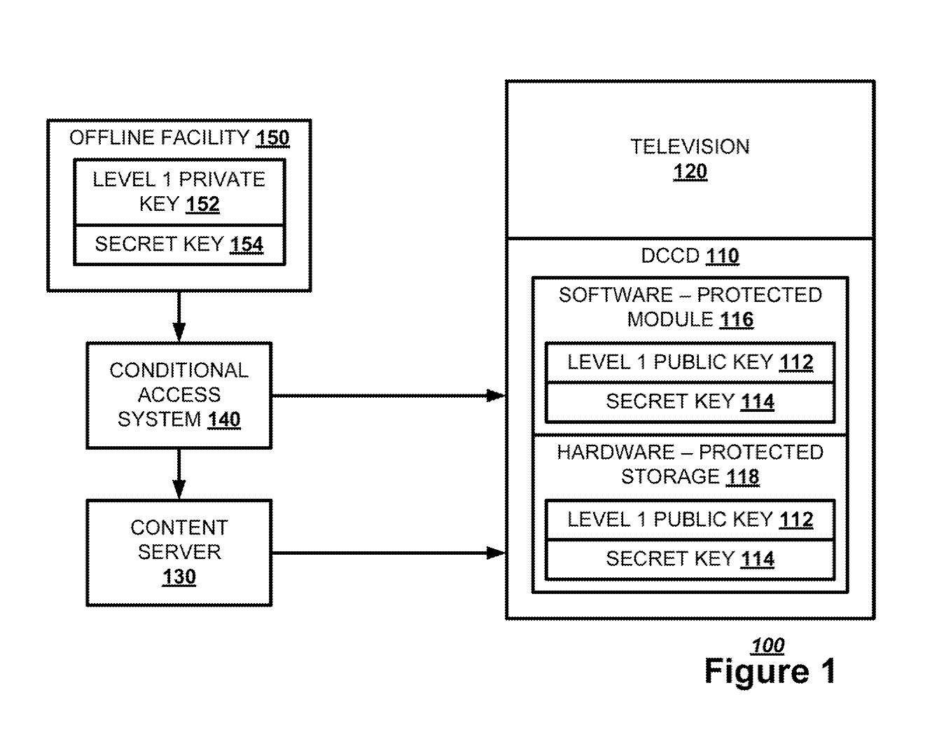

FIG. 1 illustrates, in a block diagram, one embodiment of a digital media network 100. A digital content consumption device (DCCD) 110 receives, decrypts, and routes for display and/or stores digital content, for example, a set top box for an analog or digital television set 120 or a smartphone. The digital content consumption device 110 may receive digital content from a digital content server 130 that may be viewed by the analog or digital television set 120. The digital content server 130 may forward a set of control messages from a conditional access system 140 to the digital content consumption device 110. Those control messages may be validated using a set of cryptographic public and private keys.

The conditional access system 140 may sign a control message with a private key. The digital content consumption device 110 may validate that the control message is from the conditional access system 140 using a public key matching the private key. In order to be able to change the public key that validates the control messages, a key server, such as an offline secure facility 150, may store a private key 152 that signs a transmitted public key that the conditional access system 140 sends to the digital content consumption device 110. The transmitted public key is a key that has been sent from the conditional access system 140 to the digital content consumption device 110. The digital content consumption device 110 may use a verification public key 112 corresponding to the signing private key 152 stored at the offline secure facility 150 to validate the transmitted public key. The verification public key 112 is a public key used by the digital content consumption device 110 to validate signatures from the first level private key 152. The verification public key 112 may be a first level public key, while the transmitted public key may be a second level public key. The private key in the offline secure facility 150 may be referred to as a first level private key 152, while the private key in the conditional access system 140 may be a second level private key. The first level private key 152 may pair with the first level public key 112, while the second level private key may pair with the second level public key. The digital content consumption device 110 then may use the transmitted public key to decrypt other cryptographic keys and/or values that are required to permit access to the digital content received from the digital content server 130.

The offline secure facility 150 may maintain a set of multiple second level private key and second level public key pairs. A second level public key may be encrypted using a secured secret key 154 and then included in a public key message. The public key message and the matching second level private key may be sent to the conditional access system 140. The second level private key may be separately encrypted before being sent to the conditional access system 140. The conditional access system 140 may store the second level private key and forward the encrypted public key message to the digital content consumption device 110. The digital content consumption device 110 may decrypt the encrypted public key message using a securely stored secret key 114. The digital content consumption device 110 may store the secret key 114 in a transformed manner in a non-volatile memory that comprises a software-protected module 116 that maintains the secret key and/or the first level public key (that may be used to validate the second level public key), such that the secret key and/or the first level public key is stored in non-contiguous memory locations and requires the knowledge of a secret algorithm hidden in software in order to either reconstruct or to make use of the secret key 114. In another embodiment, the digital content consumption device 110 may restrict access to the secret key and/or the first level public key by utilizing specialized hardware, that is, may use hardware-protected storage 118 for the key, for example, storing the secret key 114 in a hardware-secured location or storing the secret key in regular storage but encrypting the secret key using a hardware-protected key (for example, so that decryption of the key requires access to a special hardware application programming interface (API). For example, hardware may permit access to the secret key 114 only from a specialized security processor or from crypto hardware. Or, in hardware-protected storage 118, the key may be encrypted using a key which is only accessible from a specialized security processor or from crypto hardware. A secret key 114 stored in hardware-protected storage 118 may be more secure, but a secret key 114 in a software-protected module 116 may be updated more easily.

The securely stored secret key 114 and the offline secure facility secret key 154 may be symmetric. The securely stored secret key 114 and the offline secure facility secret key 154 may have the same value and use the same algorithm to ensure proper encryption and decryption. The digital content consumption device 110 may have a secret key 114 based on the region in which the digital content consumption device 110 is located, as long as the secret key 154 used at the offline secure facility 150 to encrypt the transmitted public key matches the secret key 114. The securely stored secret key 114 and the offline secure facility secret key 154 may have an associated initialization vector comprising a three part key, such as a key bundle comprising three DES (Data Encryption Standard) keys when utilizing a Triple Data Encryption Algorithm (TDEA). The securely stored secret key 114 and the offline facility secret key 154 also may be an asymmetric key pair, that is, the securely stored secret key 114 used by the digital content consumption device 110 to decrypt an encrypted public key message may be an asymmetric decryption key, that is, different from/have a different value than, the offline facility secret key 154 used for encryption (an asymmetric encryption key) at the offline secure facility 150, which asymmetric decryption/encryption keys may be matched up by use of an algorithm such as an RSA or an ECDSA (Elliptic Curve Digital Signature Algorithm) algorithm. In those cases, the offline facility secret key 154 is the encryption key and securely stored secret key 114 inside a device is the matching decryption key.

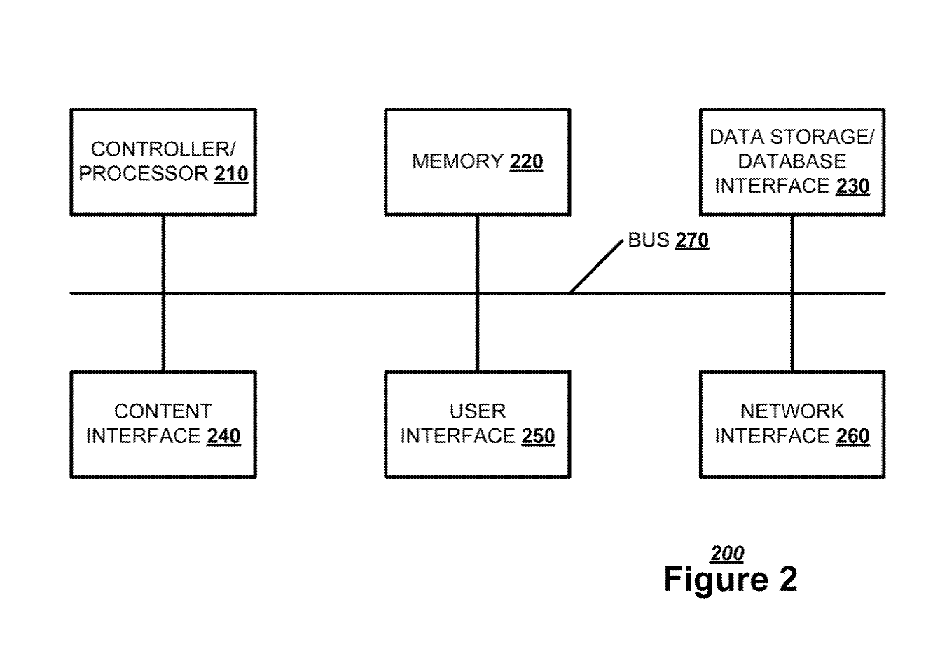

FIG. 2 illustrates a possible configuration of a computing system 200 to act as a conditional access system 140, a content server 130, or a server used to transmit data received from the offline secure facility. The computing system 200 may include a controller/processor 210, a memory 220, a database interface and associated data storage 230, a content interface 240, user interface 250, and a network interface 260, connected through bus 270. The computing system 200 may implement any operating system. Client and server software may be written in any programming language, such as C, C++, Java or Visual Basic, for example. The server software may run on an application framework, such as, for example, a Java® server or .NET® framework

The controller/processor 210 may be any programmed processor known to one of skill in the art. However, the disclosed method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the disclosed method as described herein may be used to implement the disclosed system functions of this invention.

The memory 220 may include volatile and nonvolatile data storage, including one or more electrical, magnetic or optical memories such as a random access memory (RAM), cache, hard drive, or other memory device. The memory may have a cache to speed access to specific data. The memory 220 may also be connected to a compact disc—read only memory (CD-ROM), digital video disc—read only memory (DVD-ROM), DVD read write input, tape drive, or other removable memory device that allows media content to be directly uploaded into the system.

Data may be stored in a data storage 230 or in a separate database. The data storage 230 may include hardware-protected storage for storing the second level private keys. The database interface 230 may be used by the controller/processor 210 to access the database. The database may store an encrypted set of second level private keys in hardware-protected storage.

The content interface 240 may receive content to be distributed to digital content consumption device.

The user interface 250 may be connected to one or more input devices that may include a keyboard, mouse, pen-operated touch screen or monitor, voice-recognition device, or any other device that accepts input. The user interface 250 may also be connected to one or more output devices, such as a monitor, printer, disk drive, speakers, or any other device provided to output data. The user interface 250 may receive a data task or connection criteria from a network administrator.

The network interface 260 may be connected to a communication device, modem, network interface card, a transceiver, or any other device capable of transmitting and receiving signals from the network. The network interface 260 may be used to connect a client device to a network. The components of the network server 200 may be connected via an electrical bus 270, for example, or linked wirelessly.

Client software and databases may be accessed by the controller/processor 210 from memory 220, and may include, for example, database applications, word processing applications, as well as components that embody the disclosed functionality of the present invention. The computing system 200, for example, a network server, may implement any operating system. Client and server software may be written in any programming language. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

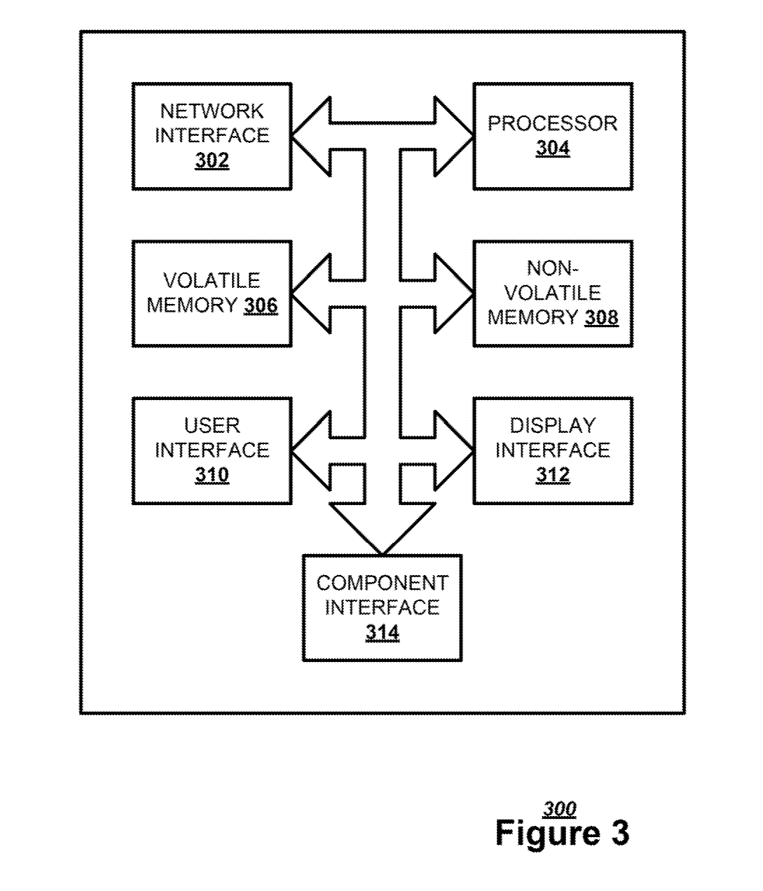

FIG. 3 illustrates one embodiment of an electronic device 300 that may act as a digital content consumption device 110. For some embodiments of the present invention, the electronic device 300 may also support one or more applications for consuming digital content. The electronic device 300 may include a network interface 302, which is capable of receiving data, such as over a cable network or other data networks. The electronic device 300 may include a processor 304 that executes stored programs. The electronic device 300 may also include a volatile memory 306 and a non-volatile memory 308 to act as data storage for the processor 304. The particular operations/functions of the processor 304, and respectively thus of the digital content consumption device 110 as described herein, are determined by an execution of software instructions and routines that are stored in one or more of volatile memory 306 and a non-volatile memory 308. However, the disclosed functionality of the digital content consumption device 110 also may be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the functionality of the digital content consumption device 110 as described herein may be used to implement the disclosed functions of this invention.

The non-volatile memory 308 further may have a hardware-protected storage 118 for storing a secret key 114 and a verification public key 112, such as a first level public key. The electronic device 300 may include a user input interface 310 that may comprise elements such as a keypad, display, touch screen, a remote control receiver and others. The electronic device 300 may also include a display interface 312 that may allow the electronic device 300 to connect to a display. The electronic device 300 also may include a component interface 314 to which additional elements may be attached, for example, a universal serial bus (USB) interface.

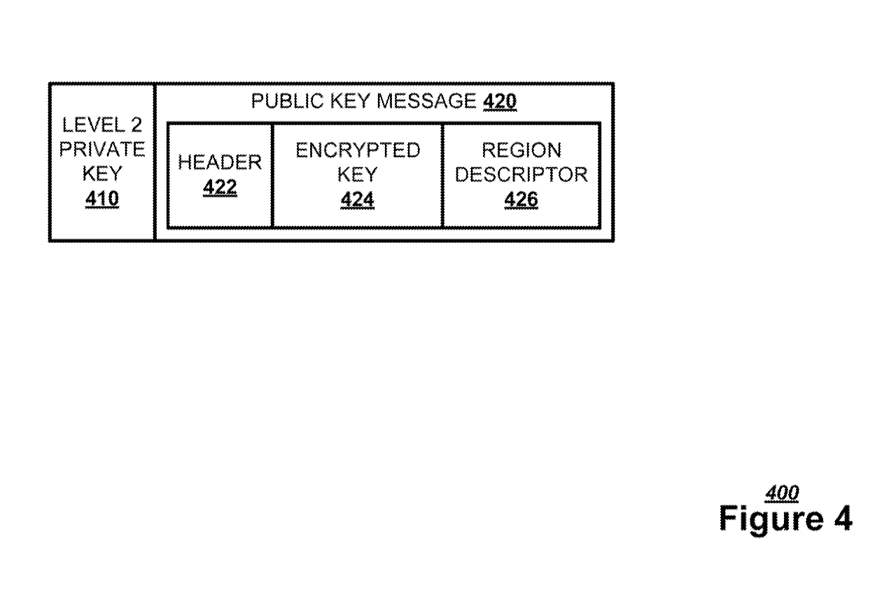

The conditional access system 140 may receive a public key update transmission from the offline secure facility 150. FIG. 4 illustrates, in a block diagram, one embodiment of public key update transmission 400. The public key update transmission 400 may have a second level private key 410 to be stored by conditional access system 140. The second level private key 410 may be separately encrypted prior to transmission to the conditional access system 140. The conditional access system 140 may decrypt the second level private key 410 upon receipt. The public key update transmission 400 may have a public key message 420 to be forwarded on to the digital content consumption device 110. The public key message 420 may have a header 422 that includes an address and routing for the public key message 420. The public key message 420 may have an encrypted key 424 that includes a transmitted public key, such as a second level public key, for the digital content consumption device 110. An administrator at the offline secure facility 150 may use the first level private key 152 to sign the second level public key prior to the encryption with the secret key 154 to yield the encrypted key 424. Alternately, an administrator at the offline secure facility 150 may use the first level private key 152 to sign the encrypted key 424 after the encryption with the secret key 154. The public key message 420 may have a region descriptor 426 that describes a region in which the digital content consumption device 110 is located.

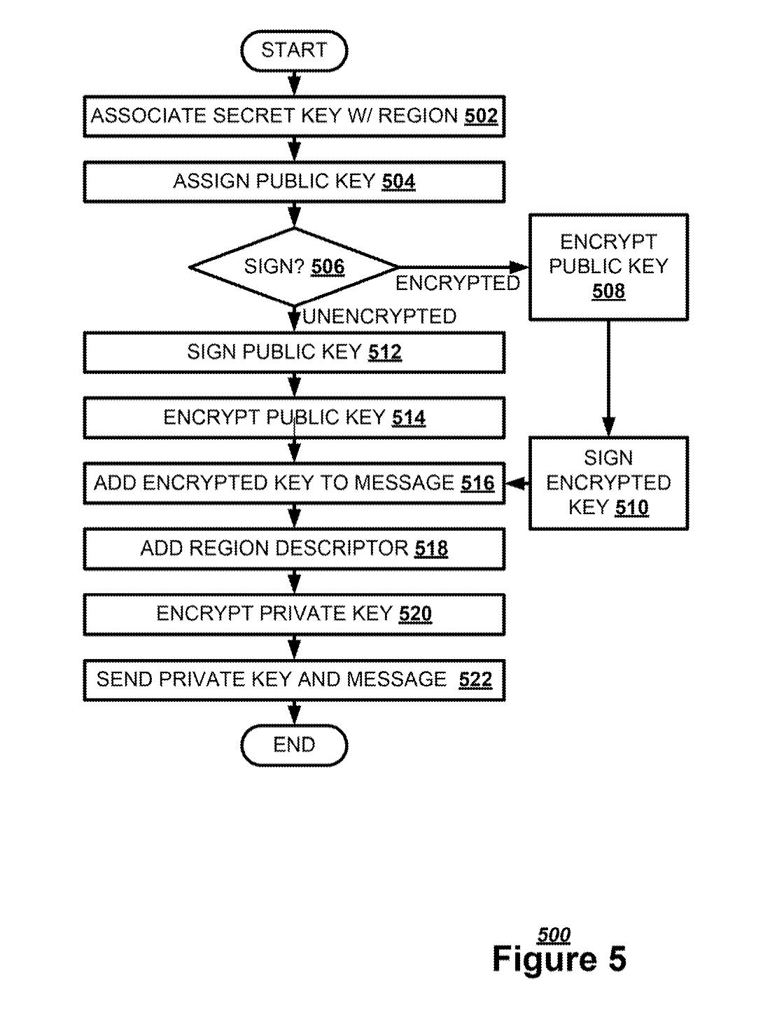

FIG. 5 illustrates, in a flowchart, one embodiment of a method 500 for updating a second level public key 424 in a digital content consumption device 110 by an administrator of the offline secure facility 150. The administrator may associate a secret key 154 with a geographic region (Block 502). The administrator may assign a transmitted public key to be sent to a digital content consumption device 110 (Block 504). The transmitted public key may be a second level public key. If the administrator wishes to sign an encrypted key 424 (Block 506), the administrator may encrypt the second level public key using a secret key 154 based on the region to create an encrypted key 424 (Block 508). The administrator may sign the encrypted key 424 with the first level private key 152 (Block 510), and the flowchart moves to Block 516. If the administrator wishes to sign an unencrypted public key (Block 506), the administrator may sign a second level public key with the first level private key 152 (Block 512). The administrator may encrypt the second level public key using a secret key 154 based on the region to create an encrypted key 424 (Block 514), and the flowchart moves to Block 516. The administrator may add the encrypted key 424 to a public key message 420 (Block 516). The administrator may add a region descriptor 426 to the encrypted public key message 420 (Block 518). The administrator may encrypt a second level private key that matches the second level public key (Block 520). The administrator may send the encrypted second level private key 410 and the public key message 420 to a conditional access system 140 (Block 522).

The key server, that is, offline secure facility 150, also may generate a shared symmetric key (SSK) which is used to deliver content decryption keys to receivers over a broadcast channel. This SSK may be encrypted using another global or unique key available to each chip (Chip Key) for secure delivery. In addition, an already encrypted SSK (ESSK) may be encrypted the second time using the second level private key. Digital content consumption device 110, upon receiving the double-encrypted ESSK, may use its region-specific second level public key to decrypt it and verify any associated hash value, in order to ensure integrity. Then, the digital content consumption device 110 may use its Chip Key to remove the final layer of encryption from SSK and utilize the decrypted SSK to gain access to digital content. Advantageously, only digital content consumption devices which are licensed for the correct region and have the corresponding second level public key are able to gain access to content decryption keys and thus to the clear digital content.

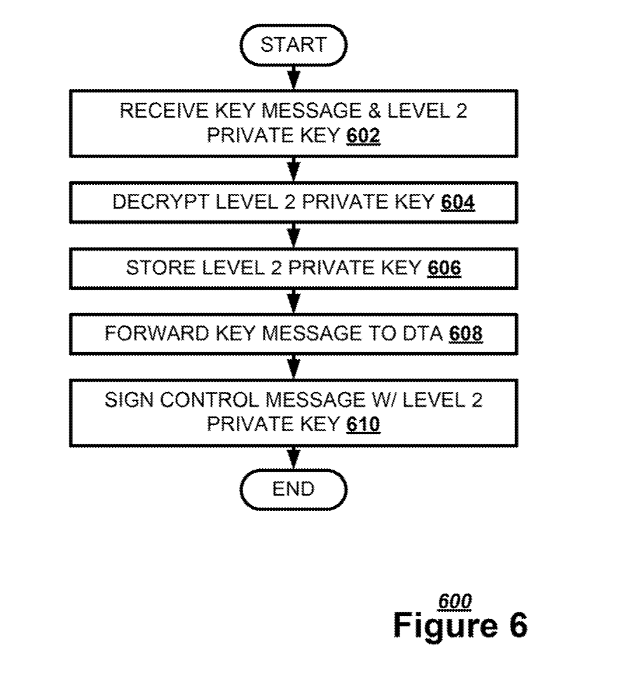

FIG. 6 illustrates, in a flowchart, one embodiment of a method 600 for updating a second level public key, such as encrypted key 424, in a digital content consumption device 110 by a conditional access system 140. A conditional access system 140 may receive an encrypted second level private key 410 and a public key message 420 that includes an encrypted key 424 associated with a region (Block 602). The conditional access system 140 may decrypt the second level private key 410 (Block 604). The conditional access system 140 may store the second level private key 410 (Block 606). The conditional access system 140 may forward the public key message 420 to a digital content consumption device 110 having a secret key 114 that decrypts the encrypted key 424 to produce a second level public key associated with the second level private key 410 (Block 608). The conditional access system 140 may sign a control message to the digital content consumption device 110 with the second level private key 410 (Block 610).

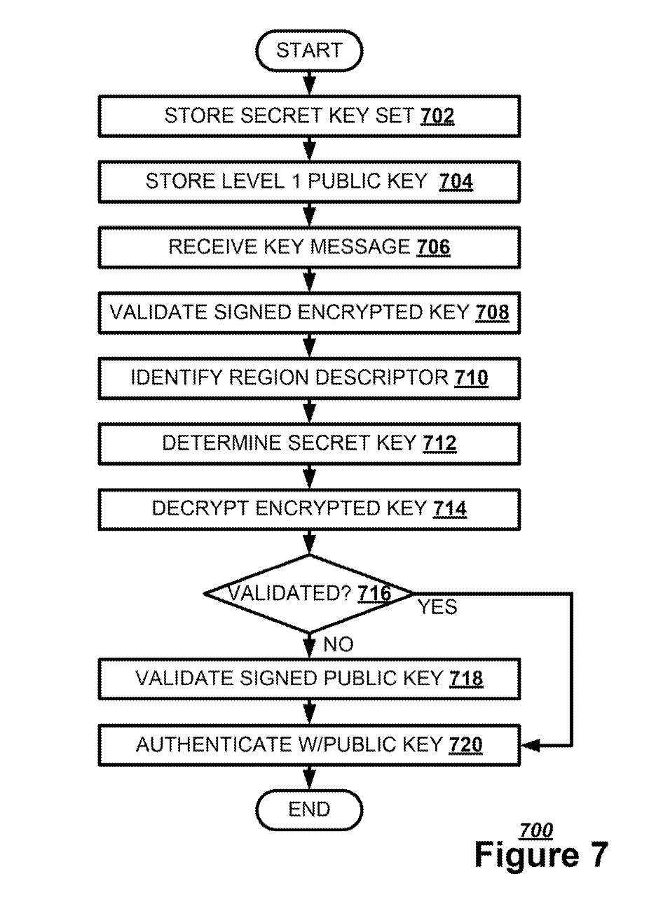

FIG. 7 illustrates, in a flowchart, one embodiment of a method 700 of activating a digital content consumption device 110. The digital content consumption device 110 may store a secret key set (Block 702). The digital content consumption device 110 may store a verification public key 112, such as a first level public key (Block 704). The digital content consumption device 110 may store the secret key set and the verification public key 112 in a transformed manner in a software-protected section 116 or in hardware-protected storage 118. The digital content consumption device 110 may receive a public key message 420 that includes an encrypted key 424 (Block 706). The digital content consumption device 110 may validate that the encrypted key 424 is a signed encrypted key 424 using the verification public key 112 (Block 708). The verification public key 112 may be a first level public key. The digital content consumption device 110 may identify a region descriptor 426 in the public key message 420 (Block 710). The digital content consumption device 110 may determine the secret key 114 from the secret key set based on the region descriptor 426 (Block 712). The digital content consumption device 110 may decrypt the encrypted key 424 using the secret key 114 to produce the transmitted public key (Block 714). The transmitted public key may be a second level public key. If the key was not previously validated as a signed encrypted key 424 (Block 716), the digital content consumption device 110 may validate the transmitted public key 424 is a signed transmitted public key using a verification public key 112 (Block 718). Thus the first level public key 112 may validate that the second level public key is a signed second level public key. The digital content consumption device 110 may use the transmitted public key to authenticate a control message (Block 720).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for key-based decryption, the method comprising:
receiving, in a digital content consumption device, a public key message comprising an encrypted key;
identifying a region descriptor in the public key message;
determining a secret key based on the region descriptor; and
decrypting the encrypted key using the secret key to produce a transmitted public key.

2. The method of claim 1, further comprising validating that the transmitted public key is a signed transmitted public key.

3. The method of claim 2, further comprising validating the signed transmitted public key using a verification public key.

4. The method of claim 1, further comprising validating that the encrypted key is a signed encrypted key.

5. The method of claim 1, further comprising storing a secret key set.

6. The method of claim 1, further comprising storing the secret key in a software-protected module.

7. The method of claim 1, further comprising restricting access to the secret key with specialized hardware.

8. The method of claim 1, further comprising using the received public key to authenticate a control message.

9. The method of claim 1, further comprising using the received public key to decrypt one or more of a cryptographic key and a cryptographic value required for content access.

10. The method of claim 1, wherein the secret key is an asymmetric decryption key having a different value than a corresponding encryption key.

11. A digital content consumption device comprising:
a communication interface that receives in a digital content consumption device a public key message comprising an encrypted key; and
a processor that is configured to identify a region descriptor in the public key message, determine a secret key based on the region descriptor, and decrypt the encrypted key using the secret key to produce a second level public key.

12. The digital content consumption device of claim 11, wherein the processor is configured to identify a region descriptor in the public key message.

13. The digital content consumption device of claim 11, wherein the processor is configured to determine the secret key based on the region descriptor.

14. The digital content consumption device of claim 11, further comprising a non-volatile memory that comprises a software-protected module that maintains at least one of the secret key and a first level public key that validates the second level public key.

15. The digital content consumption device of claim 11, further comprising specialized hardware that restricts access to at least one of the secret key and a first level public key that validates the second level public key.

16. The digital content consumption device of claim 11, wherein the processor is configured to validate that the second level public key is a signed second level public key.

17. The digital content consumption device of claim 11, wherein the processor is configured to validate that the encrypted key is a signed encrypted key.

18. The digital content consumption device of claim 11, wherein the processor is configured to use the second level public key to authenticate a control message.

19. The digital content consumption device of claim 11, wherein the processor is configured to use the received public key to decrypt one or more of a cryptographic key and a cryptographic value required for content access

20. The digital content consumption device of claim 11, wherein the secret key is an asymmetric decryption key having a different value than a corresponding encryption key.

21. A conditional access system, comprising:
a communication interface that receives a second level private key and a public key message comprising an encrypted key associated with a region and forwards the public key message to a digital content consumption device having a secret key that decrypts the encrypted key to produce a second level public key associated with the second level private key; and
a data storage that stores the second level private key.

22. The conditional access system of claim 21, further comprising a processor that is configured to sign a control message to the digital content consumption device with the second level private key.
